(19) United States
(12) Patent Application Publication
(10) Pub. No.: US 2002/0046141 A1
(43) Pub. Date: Apr. 18, 2002

(54) Stock management device and stock management method for call sales

(75) Inventor: Kenji Tsumura, Saga-shi (JP)

Correspondence Address: JORDAN AND HAMBURG LLP, 122 EAST 42ND STREET, SUITE 4000, NEW YORK, NY, 10168, US

(73) Assignee: Kentop Corporation, Saga-shi (JP)

(21) Appl. No.: 09/915,729

(22) Filed: Jul. 26, 2001

(30) Foreign Application Priority Data
Aug. 8, 2000 (JP) 2000-240310

(51) Int. Cl. G06F 17/60

(52) U.S. Cl. 705/28

(57) ABSTRACT

In the field of call sales, a stock management device and stock management method are provided for preventing stock from running out and preventing defective stock from being generated. The amount of a product to be consigned to each customer, the amount consumed by the customer, and the call cycle for the customer are each input using an input means 11 and are then stored in storage means 12. A consumption rate calculation means 13 acquires both the amount of the product to be consigned and the amount of the product consumed from the storage means 12 and calculates the rate of consumption of the product by all customers. This is then stored in the storage means 12. A total consumption amount calculation means 14 acquires both the amount of the product consumed and the call cycle from the storage means 12 and calculates the total amount of consumption over a predetermined period. This is further stored in the storage means 12. A lower limit setting means 15 acquires both the rate of consumption and the total amount of consumption from the storage means 12 and calculates the amount of product that is necessary to be consigned to the customer for the subsequent period. This is then set as the minimum amount of stock. Output means 17 then outputs the set minimum stock amount.

### BACKGROUND OF THE INVENTION

1. Field of the Invention

The present invention relates to a stock management device and a stock management method for managing stocks of various types of products that are delivered and consigned to a customer in the field of call sales of medical supplies and various other products.

2. Description of the Related Art

In the field of call (i.e. door-to-door) sales of medical supplies and the like, conventionally, a system has been used in which a medicine chest containing several types of medicines having various beneficial effects is consigned to a customer. After an appropriate time has passed, a call sales operator (referred to below as a salesperson) visits the customer and receives payment from the customer for those medicines that the customer has used from the medicine chest and also replenishes the supplies of the used medicines.

In this type of system, what is known as the consigned medicine data, which comprises the items and numerical quantities of the medicines kept by the customer and the medicines used by the customer and the like, has been conventionally recorded in an account book known as an order estimate book. However, recently, methods of record and management using computers have become increasingly widespread.

On the other hand, since the management of the types of medicines in the medicine chest consigned to the customer has been entrusted to the salesperson who visits the customer, all of the various management tasks relating to the types of medicines, the numerical quantities thereof, the limits on the time they are left with the customer, and so on, have been performed by the individual salespersons. When visiting the customer, each salesperson sets the call cycle for calling on the customer and replenishes the used medicines according to various data relating to the customer depending on the salesperson's experience.

It should be noted that the overall merchandise stock such as medicines used in call sales can be classified into warehouse stock held at distribution bases such as sales offices, salesperson stock that is kept by each salesperson, and customer stock that has been consigned to the customer.

Each salesperson manages the customer stock on the basis of the salesperson's own experience and, when necessary, replenishes the medicines of the customer from the salesperson's stock. When the salesperson's stock diminishes, the salesperson replenishes that stock from the warehouse stock. At the head office, order requests from each sales office that manages a warehouse stock are received and orders are sent out to the relevant pharmaceutical company.

However, according to the above conventional stock control method, orders are made considering only the stock of each sales office such as the stock of each salesperson or the warehouse stock and, since it is not possible to predict the cycle at which each salesperson calls on a customer and replenishes the customer's medicine chest, overstocking frequently occurs.

Since products such as medicines have a fixed expiry date, surplus stock which is in excess of the amount that can be consumed leads to defective stock such as stock that has passed its expiry date. Moreover, if the total amount of stock is set in advance at a low amount in order to prevent surplus stock, the stock may run out, and sales opportunities may be lost.

Therefore, in the present invention, there are provided a stock management device and a stock management method for use in call sales which prevent stock from running out and also prevent stock from becoming defective.

### SUMMARY OF THE INVENTION

According to the present invention, in the field of call sales, the stock management device for managing a total amount of stock of a product which is consigned to a customer comprises: means for inputting an amount of a product to be left with the customer, an amount of a product consumed by the customer, and a call cycle for each customer; first storage means for storing the input amount of a product left with the customer; second storage means for storing the input amount of a product consumed by the customer; third storage means for storing the input call cycle; means for acquiring both the amount of a product left with the customer from the first storage means and the amount of a product consumed by the customer from the second storage means and calculating a rate of consumption of the product by all customers; fourth storage means for storing the calculated rate of consumption; means for acquiring both the amount of a product consumed by the customer from the second storage means and the call cycle from the third storage means and calculating a total amount of consumption over a predetermined time; fifth storage means for storing the calculated total amount of consumption; lower limit setting means for acquiring both the rate of consumption from the fourth storage means and the total amount of consumption from the fifth storage means, calculating the amount which is necessary to be left with the customer for a subsequent period, and setting this as a minimum stock amount; and means for outputting the set minimum stock amount.

The result of this is that by calculating the amount of a product requiring to be left with a customer for the subsequent period from the rate of consumption and the total amount of consumption and setting this as a minimum stock amount, and by managing the total stock amount of the product so that it does not drop below the minimum stock amount, it is possible to prevent stock from running out and, as surplus stock is not built up, it is also possible to prevent defective stock from being generated.

Here, in addition to the amount of a product consumed by each customer being input directly from a personal computer or portable input/output terminal, it is also possible to input indirectly by inputting the stock of the product held by the customer and the numerical quantity to be consigned and then transferring the amount consumed that is calculated based on these. In addition to the value of the call cycle being input directly in the same way, it is also possible to input indirectly by transferring a value generated automatically using a schedule generating device or the like.

Moreover, it is preferable that the stock management device of the present invention comprises: means for inputting an expiry date of the product; sixth storage means for storing the input expiry date; upper limit setting means for setting a maximum stock amount based on the rate of consumption acquired from the fourth storage means, the expiry date acquired from the sixth storage means, and the set minimum stock amount; and means for outputting the maximum stock amount.

The result of this is that by setting the maximum stock amount based on the expiry date of the product and managing the total stock amount of the product so that it does not go above this maximum stock amount, it is possible to prevent a product from passing its expiry date and the generation of defective stock is even more thoroughly prevented.

Moreover, it is preferable that the stock management device of the present invention comprises seventh storage means for storing the consumed amount per month, and that the lower limit setting means acquires the amount of a product consumed for the same month of the previous year from the seventh storage means and adds the amount consumed to parameters for calculating the amount of the product necessary to be consigned to the customer.

The result of this is that it is possible to more accurately calculate the amount of products whose consumption trends change with the seasons such as health drinks in summer and cold remedies in winter that need to be consigned to a customer for the subsequent period and to set the minimum stock amount.

In the stock management method of the present invention: in the field of call sales, an amount of a product to be left with the customer, an amount of a product consumed by the customer, and a call cycle for each customer are input and stored; the stored amount of a product to be left with the customer and the amount of a product consumed by the customer are both acquired and a rate of consumption of the product by all customers is calculated and stored; the stored amount of a product consumed by the customer and the call cycle are both acquired and a total amount of consumption over a predetermined period is calculated and stored; the stored rate of consumption and the total amount of consumption are both acquired and an amount necessary to be left with the customer for a subsequent period is calculated and set as a minimum stock amount; and a total amount of stock of a product is managed based on the set minimum stock amount. The result of this is that it is possible to prevent stock from running out by managing the total amount of stock of a product such that it does not drop below this minimum stock amount.

In the stock management method of the present invention, it is preferable that an expiry date of the product is also input; the stored rate of consumption and the expiry date are both acquired; a maximum stock amount is set based on the acquired rate of consumption and expiry date and on the set minimum stock amount; and the total amount of stock of the product is managed based on the set maximum stock amount. The result of this is that it is possible to prevent a product from passing its expiry date by managing the total amount of stock of that product such that the upper limit on the amount of stock is not exceeded.

### BRIEF DESCRIPTION OF THE DRAWINGS

FIG. 1 is a schematic view of the stock management system in an embodiment of the present invention.

FIG. 2 is a block diagram showing stock management functions of the host computer shown in FIG. 1.

FIG. 3 is a flow chart showing the processing of the stock management system in the present embodiment.

FIG. 4 is a diagram showing an example of an output purchase limit examination table.

### DESCRIPTION OF THE PREFERRED EMBODIMENTS

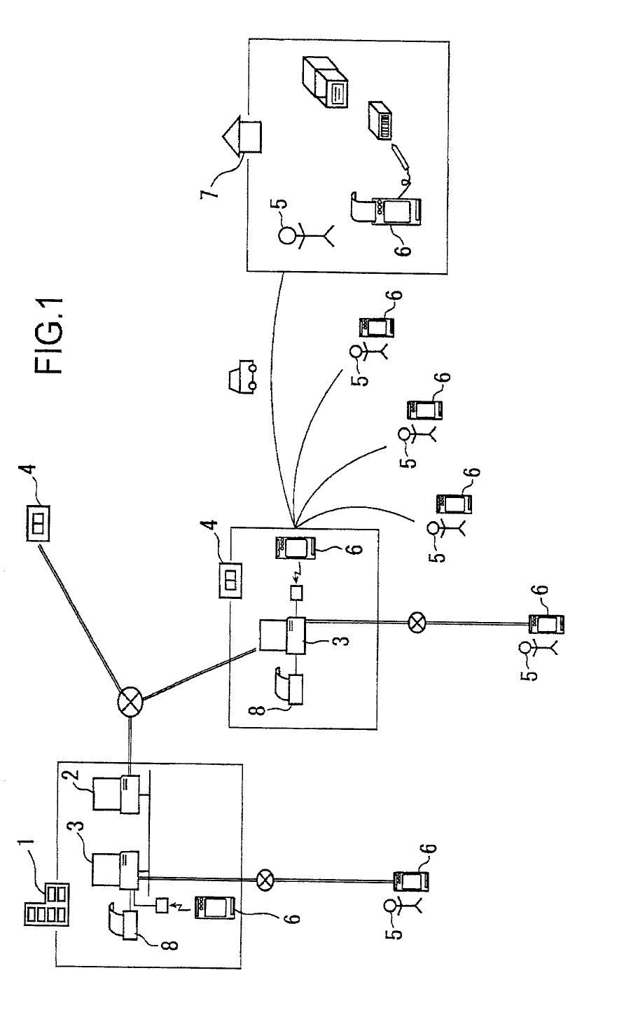

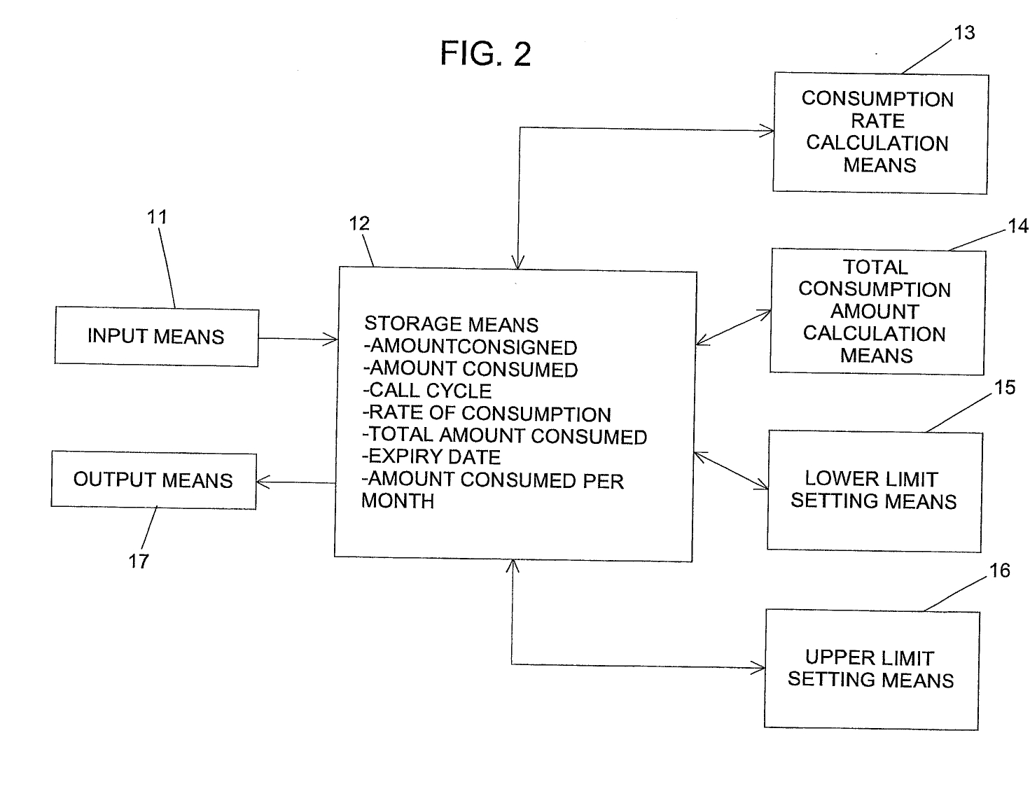

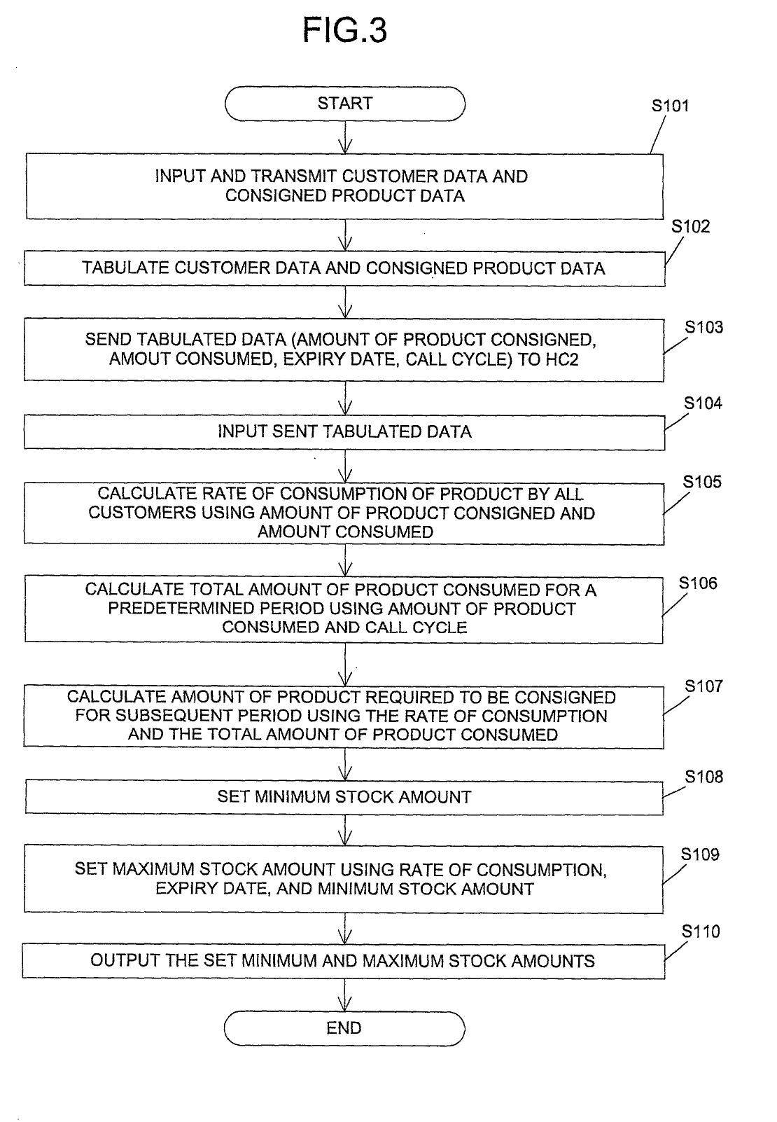

FIG. 1 is a schematic view of the stock management system in an embodiment of the present invention; FIG. 2 is a block diagram showing stock control functions of the host computer shown in FIG. 1; and FIG. 3 is a flow chart showing the processing of the stock management system in the present embodiment.

As is shown in FIG. 1, a host computer (referred to below as HC) 2 for data tabulation analysis and a personal computer (referred to below as PC) 3 for data communication which is connected to the host computer 2 are installed in a head office 1. A PC 3 is also installed in each sales office 4 and each sales person 5 carries a portable input/output terminal (referred to below as HT) 6.

The salesperson 5 inputs and records on the HT 6 all data relating to a customer 7 serving as the client, such as data on the customer and data on the products consigned to that customer. Tabulation analysis is performed when the customer data and product data recorded in the HT 6 are sent to the PC 3. For the means of communication between the HT 6 and the PC 3, a telephone line, infrared communication, a PC card, or the like may be used, and a data file transfer is performed using these means.

The customer data include an area code, the customer's name, the customer's address, the call cycle, the date of the previous call, the days when the customer is present, the time when the customer is present, a residential map page, the previous credit balance, a record of the sales, the total sales amount, the amount recovered, the current credit balance, the date of the next payment collection, a clinical history, and the like. The product data include product names, regular prices of the product, product efficacy, names of the manufacturer, selling prices, discounts, customer stock, limits on the time the product is left with the customer, consigned product items, consigned product quantity instructions, salesperson stock items, salesperson stock numerical quantities, limits on expiry dates, total prices, and the like.

The salesperson 5 calls on the customer in accordance with the call cycle of each customer. When the task of calling on the customer 7 is ended, the salesperson 5 sends the customer data and product data input into the HT 6 to the PC 3 (step S101). When the salesperson 5 is out, the day's transaction data can be transmitted from the HT 6 to the PC 3 by sending the data directly to the PC 3 by PC communication using a telephone line from the HT 6 carried by the salesperson 5. The customer data and product data sent to the PC are tabulated by the PC 3 (step S102), and the tabulated data is sent to the HC 2 (step S103).

In FIG. 2, the HC 2 is provided with an input means 11 for inputting tabulated data sent from the PC 3, a storage means 12 for storing the input tabulated data and calculation results and the like, a consumption rate calculation means 13 for calculating the rate of consumption by all customers of a particular product, a total consumed amount calculation means 14 for calculating the total amount of a particular product consumed over a predetermined time, a lower limit setting means 15 for setting the lower limit of an amount of stock when ordering a product, an upper limit setting means 16 for setting an upper limit of an amount of stock when purchasing a product, and an output means 17 for outputting the data to the PC 3 and printer 8.

The tabulated data sent from the PC 3 is input by the input means 11 and stored in the storage means 12 (step S104). The amount of product, the amount consumed (i.e. the amount sold), and the call cycle for each customer shown in Table 1 are used as the tabulated data stored in the storage means 12 for each product.

TABLE 1

| | AMOUNT | AMOUNT | |
|---|---|---|---|
| CUSTOMER NAME | CONSIGND | CONSUMED | CALL CYCLE |
| CUSTOMER A | 4 | 1 | 30 DAYS |
| CUSTOMER B | 6 | 1 | 60 DAYS |
| CUSTOMER C | 4 | 1 | 30 DAYS |
| CUSTOMER D | 2 | 1 | 30 DAYS |
| CUSTOMER E | 4 | 1 | 90 DAYS |
| TOTAL | 20 | 5 | — |

The consumption rate calculation means 13 acquires the amount of product and the amount consumed stored in the storage means 12 and calculates the rate of consumption for all customers of that product using the following formula. The results of the calculation are then stored in the storage means 12 (step S105).

rate of consumption=total of amount consumed by all customers/total product amount for all customers

For example, as is seen in Table. 1, as the amount consumed by all customers is 5 and the total product amount for all customers is 20, the rate of consumption is 5/20=0.25.

The total consumed amount calculation means 14 acquires the amount consumed and the call cycle stored in the storage means 12 and calculates the total amount consumed for that product over a predetermined time (for example, one year) using the following formula. The results of the calculation are then stored in the storage means 12 (step S106).

total consumed amount (one year)=number of days in the year×amount consumed per day

For example, as is seen in Table 1, as the average call cycle of all customers is 48 days and the total of the amount consumed by all customers is 5, the amount consumed per day is the total amount consumed by all customers/the average call cycle for all customers, which is 5/48. Thus, the total amount consumed (for one year) is 365×5/48=38.

The lower limit setting means 15 acquires the rate of consumption and the total amount consumed stored in the storage means 12 and, based on these, calculates the amount of product necessary to be left with the customer for the next period using the following formula (step S107). The results of the calculation are set as the minimum stock amount (step S108) and stored in the storage means 12.

amount of product necessary to be left (i.e. the minimum stock amount)=total consumed amount (one year)/rate of consumption

For example, the amount of product necessary to be left for Table 1 is the amount of product necessary to be left for the next period (in the present embodiment, the next period equates to the next year as the predetermined period is set as one year) and is 38/0.25=152.

In addition, in the present embodiment, the amount consumed per month shown in table 2 is used as tabulated data stored in the storage means 12 for each product.

TABLE 2

| PRODUCT NAME | 1999/JUN | JUL | AUG | SEP | OCT | NOV | DEC | 2000/JAN | FEB | MAR | APR | MAY | JUN |
|---|---|---|---|---|---|---|---|---|---|---|---|---|---|
| X | 2 | 4 | 5 | 2 | 3 | 4 | 6 | 10 | 2 | 4 | 3 | 1 | 3 |
| Y | 3 | 5 | 1 | 2 | 3 | 3 | 2 | 1 | 2 | 3 | 3 | 2 | 4 |

In the present embodiment, the lower limit setting means 15 acquires the amount of the product consumed for the same month of the previous year from the storage means 12 and adds this as a parameter used for calculating the amount of product necessary to be left. Specifically, the rate of increase or decrease in consumption of the relevant product is determined from the amount of that product consumed for the same month of the previous year, and the amount of product necessary to be left for the next period is calculated using the following formula. The results of the calculation are then stored in the storage means 12.

amount of product necessary to be left (i.e. the minimum stock amount)=total consumed amount (one year)×rate of increase or decrease in consumption/rate of consumption

For example, as is seen in Table 2, the rate of increase or decrease in consumption of product X for June 2000 is the amount consumed for June 2000/the amount consumed for June 1999, which is 3/2=1.5. The amount of product X necessary to be left with the customer is thus 38×1.5/0.25=228.

Moreover, in the present embodiment, the expiry date of each product is used as tabulated data stored in the storage means 12 (step S102). The upper limit setting means 16 acquires the rate of consumption calculated by the consumption rate calculation means 13 and the minimum stock amount set by the lower limit setting means 15 and, based on these values, sets the maximum stock amount using the following formula (step S109) This is then stored in the storage means 12.

Maximum stock amount=minimum stock amount+(expiry date−1)×minimum stock amount×rate of consumption

For example, in the example described above, as the minimum stock amount is 228 and the rate of consumption is 0.25, when the expiry date of this product is set for 5 years, the maximum stock amount is 228+(5−1)×228×0.25=456.

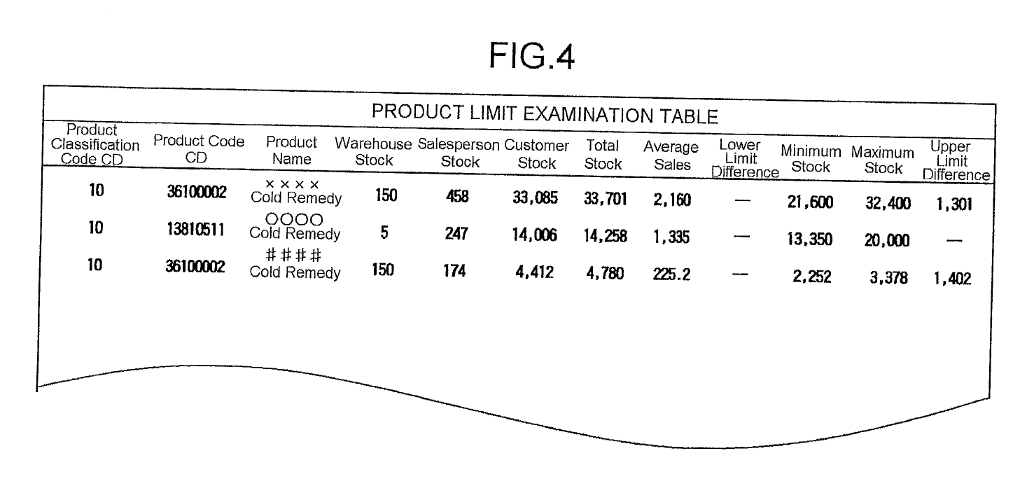

The maximum stock amount and the minimum stock amount which have been set as described above are output using the output means 17 as the purchase limit examination table shown in FIG. 4 (step S110). In this purchase limit examination table, the product classification code (CD) and the product code (CD) for each product and the respective warehouse stocks, salesperson stocks, customer stocks, total stocks, average sales, lower limit difference, minimum stock, maximum stock and upper limit difference are shown as numerical quantities. In the purchase limit examination table shown in FIG. 3, the upper limit difference is the difference between the total stock amount and the maximum stock amount, which shows the amount of a product that is anticipated becoming surplus stock (i.e. defective stock). The lower limit difference is the difference between the total stock amount and the minimum stock amount and shows the amounts of products of which stock is anticipated running out.

By managing the total stock amount of a product using this type of purchase limit examination table so that it does not drop below the minimum stock amount, it is possible to prevent stock from running out and, since surplus stock is not built up, it is also possible to prevent defective stock from being generated. Furthermore, by managing the total stock amount of a product so that it does not exceed the maximum stock amount, it is possible to prevent a product from passing its expiry date, and the generation of defective stock is even more thoroughly prevented.

Additionally, because the rate of increase or decrease in the consumption of a product is determined from the amount of the product consumed in the same month of the previous year and is used as one of the parameters for calculating the amount of the product which is necessary to be left with the customer, it is possible to more accurately calculate the amount to be left for the subsequent period for the products of which consumption trends change with the seasons, such as health drinks in summer and cold remedies in winter, and to set the minimum stock amount.

While the preferred form of the present invention has been described, it is to be understood that modifications will be apparent to those skilled in the art without departing from the spirit of the invention. The scope of the invention, therefore, is to be determined solely by the following claims.

What is claimed is:

1. In the field of call sales, a stock management device for managing a total amount of stock of a product that is consigned to a customer comprising:
means for inputting an amount of a product to be consigned to the customer, an amount of a product consumed by the customer, and a call cycle for each customer;
first storage means for storing the input amount of a product consigned to the customer;
second storage means for storing the input amount of a product consumed by the customer;
third storage means for storing the input call cycle;
means for acquiring both the amount of a product consigned to the customer from the first storage means and the amount of a product consumed by the customer from the second storage means and calculating a rate of consumption of the product by all customers;
fourth storage means for storing the calculated rate of consumption;
means for acquiring both the amount of a product consumed by the customer from the second storage means and the call cycle from the third storage means and calculating a total amount of consumption over a predetermined time;
fifth storage means for storing the calculated total amount of consumption;
lower limit setting means for acquiring both the rate of consumption from the fourth storage means and the total amount of consumption from the fifth storage means, calculating an amount necessary to be consigned to the customer for a subsequent period, and setting the calculated amount necessary to be consigned as a minimum stock amount; and
means for outputting the set minimum stock amount.

2. The stock management device used in call sales according to claim 1 further comprising:
means for inputting an expiry date of the product;
sixth storage means for storing the input expiry date;
upper limit setting means for setting a maximum stock amount based on the rate of consumption acquired from the fourth storage means, the expiry date acquired from the sixth storage means, and the set minimum stock amount;
and means for outputting the maximum stock amount.

3. The stock management device used in call sales according to claim 1 or 2 further comprising seventh storage means for storing the consumed amount per month, wherein the lower limit setting means acquires the amount of a product consumed for the same month of the previous year from the seventh storage means and adds the amount consumed to parameters for calculating the amount of the product necessary to be consigned to the customer.

4. A stock management method used in the field of call sales wherein:
an amount of a product to be consigned to the customer, an amount of a product consumed by the customer, and a call cycle for each customer are input and stored;
the stored amount of a product to be consigned to the customer and the amount of a product consumed by the customer are both acquired and a rate of consumption of the product by all customers is calculated and stored;
the stored amount of a product consumed by the customer and the call cycle are both acquired and a total amount of consumption over a predetermined period is calculated and stored;
the stored rate of consumption and the total amount of consumption are both acquired and an amount necessary to be consigned to the customer for a subsequent period is calculated and set as a minimum stock amount; and
a total amount of stock of a product is managed based on the set minimum stock amount.

5. The stock management method used in the field of call sales according to claim 4, wherein an expiry date of the product is input and stored; the stored rate of consumption and the expiry date are both acquired; a maximum stock amount is set based on the acquired rate of consumption and expiry date and on the set minimum stock amount; and the total stock amount of the product is managed based on the set maximum stock amount.
